(19) United States
(12) Patent Application Publication
(10) Pub. No.: US 2021/0185792 A1
(43) Pub. Date: Jun. 17, 2021

(54) CT X-RAY TUBE WITH AN ANODE PLATE WHERE ANGULAR VELOCITY VARIES WITH TIME

(71) Applicant: KONINKLIJKE PHILIPS N.V., EINDHOVEN (NL)

(72) Inventors: CLAAS BONTUS, HAMBURG (DE); TOBIAS REUSCH, HAMBURG (DE); BERND RUDI DAVID, HUETTBLEK (DE)

(21) Appl. No.: 17/269,678

(22) PCT Filed: Aug. 21, 2019
(86) PCT No.: PCT/EP2019/072324

§ 371 Date: Feb. 19, 2021

(30) Foreign Application Priority Data
Aug. 30, 2018 (EP) 18191804.6

(51) Int. Cl. H05G 1/66; H05G 1/62; H01J 35/26; H01J 35/10

(52) U.S. Cl. CPC H05G 1/66; H01J 35/101; H01J 35/26; H05G 1/62

(57) ABSTRACT

A computer tomography x-ray tube for generating pulsed x-rays is presented. The x-ray tube comprises an anode and an electron emission unit for generating a pulsed electron beam onto the anode. Furthermore, a rotation mechanism for rotating the anode characterized in that the rotation mechanism is configured for rotating the anode with an angular velocity that varies in time is comprised. The rotation mechanism may also be configured for rotating the anode such that the variation of the angular velocity in time is a continuous oscillation around a mean angular velocity ω₀ in time. In a preferred embodiment the angular velocity ω (t) varies in time according to the following formula:

ω(t)=ω₀+Δω sin Ωt,

wherein ω₀ is a mean angular velocity. In a particular embodiment, the grid switch for generating the pulsed electron beam is comprised and the x-ray tube may be embodied as a stereo tube, in which two focal spots of electron beams are generated in an alternating manner.

### FIELD OF THE INVENTION

The present invention relates to x-ray tubes in computer tomography imaging systems. In particular, the present invention relates to computer tomography x-ray tubes, computer tomography devices for generating images of a patient and relates to a method of generating pulsed x-ray radiation with a rotating anode and a pulsed electron beam.

### BACKGROUND OF THE INVENTION

The generation of x-rays in x-ray tubes used in imaging involves several technical hurdles. For example, EP421009A1 tries to solve problems originating from rotation frequencies of the anode of the x-ray tube that are identical to resonance frequencies. It is thus suggested in EP421009A1 to provide a solution which measures and controls the rotation frequency of the anode such that no negative effects from resonance frequencies Occur.

In document DE 102011005115 A1 it is tried to solve problems occurring in some applications if the anode plate and the frequency of the x-ray beam are not in synchronization. It therefore sets the frequency of the anode plate being a constant integer multiple of the x-ray frequency. However, this requires a precise measuring and controlling of the anode frequency.

US2014/355736A1 describes that switching units are configured to switch the intensity of X-rays to be generated by an anode. It is described that an X-ray controller controls the switching units to switch the intensity of the X-rays to be generated by the anode, and controls a rotor control power generator to rotate the anode. It is described that when a value approximately equal to an integer multiple of an X-ray intensity switching period designated by a user coincides with the rotor rotation period, the X-ray controller controls the rotor control power generator to shift the thermoelectron collision ranges of the anode in the first turn from thermoelectron collision ranges in the second turn.

The inventors of the present invention have identified that future x-ray tubes, especially the ones used in computer tomography (CT) imaging, will utilize a so-called grid switch. This allows switching the electron beam on and off in very short intervals. Care must be taken that the electron beam does not hit the same positions of the anode plate after each rotation since this would lead to non-uniform heating. A special case is given by a stereo tube in which two focal-spots are used in an alternating manner. Here the targeted power for each focal-spot can get quite high during periods of illumination. Therefore, the inventors of the present invention found that heating up identical areas of the anode after each rotation can mean a major drawback.

### SUMMARY OF THE INVENTION

The object of the present invention may be seen in providing for an improved generation of x-rays for computer tomography imaging.

The object of the present invention is solved by the subject-matter of the independent claims. Further embodiments and advantages of the invention are incorporated in the dependent claims.

The described embodiments similarly pertain to the computer tomography x-ray tube, the computer tomography device and to the method of generating pulsed x-ray radiation. Synergetic effects may arise from different combinations of the embodiments although they might not be described in detail hereinafter.

Further on, it shall be noted that all embodiments of the present invention concerning a method, might be carried out with the order of the steps as described, nevertheless this has not to be the only and essential order of the steps of the method. The herein presented methods can be carried out in another order of the disclosed steps without departing from the respective method embodiment, unless explicitly mentioned to the contrary hereinafter.

According to a first aspect of the present invention, a computer tomography x-ray tube for generating pulsed x-rays is presented. The x-ray tube comprises an anode and an electron emission unit, which generates the pulsed electron beam onto the anode for generating the pulsed x-rays. Furthermore, a rotation mechanism for rotating the anode is comprised. The rotation mechanism is configured for rotating the anode with an angular velocity which varies in time.

The disadvantages overcome the present invention is that the likelihood of an unfortunate heating of the anode will significantly be reduced due to the anode which rotates with an angular velocity that varies in time. This is true for nearly all electron beam switching patterns and hence the present invention can be beneficially applied in many scenarios. Several different time variations may used by the skilled person.

The proposed solution is cost-efficient since no complex controlling mechanism for measuring and controlling the anode frequency is required by the present invention. The desired time variation of the anode frequency can be pre-defined. The desired and pre-defined time variation may be e.g. stored in a unit that drives the rotation of the anode. For example, the rotation mechanism of the CT x-ray tube may store and cause the desired and pre-defined time variation of the anode rotation. In a particular embodiment, the angular velocity ω (t) of the anode varies in time according to the following formula:

ω(t)=ω₀+Δω sin Ω(t),

wherein ω₀ is a mean angular velocity preferably ω₀ is not 0. This will be explained and elucidated in more detail hereinafter.

Advantageously, the variation of the angular velocity in time of the anode ensures that during a rotational movement of a gantry in a CT device during imaging, the angular velocity of the anode and said rotational movement are desynchronized.

Further, the used rotation mechanism does not require measuring and controlling a rotation frequency of the anode and no feedback loop in this respect is needed. By setting an angular velocity that varies in time in a predefined manner, by configuring the rotation mechanism accordingly, the desired reduction of a likelihood of an unfortunate heating of the anode is achieved.

In a conventional x-ray tube, the anode rotates at a constant angular position velocity, which is for example a 180 Hz. However, the inventors of the present invention found that future tubes will contain grid switches. These allow turning on and off the electron beam hitting the anode plate. In certain scenarios, the power of the electron beam can get quite large during periods in which the beam is on, while average power remains modest. Now, if the frequency of the switched beam and the frequency of the anode plate are in phase, the anode plate will be hit at the same positions after each rotation. This is quite inappropriate with respect to heat consumption and aging. Care must therefore be taken that the two frequencies, the anode rotation frequency and the grid switching frequency, do not coincide. In practice, this means that the speed of the anode plate must be measured quite accurately and adjusted if necessary.

However, the inventors of the present invention have found that for the following reasons, such a controlled approach is difficult to realize. First, future scan protocols are likely to require quite a large number of grid switching patterns. For each of these patterns, the optimal anode plate frequency needs to be determined. Second, gantry rotation speed varies and data acquisition is triggered by the angular position of the tube detector system. The optimal frequency of the anode is therefore difficult to predict. In contrast to these drawbacks of other approaches, according to the first aspect of the present invention, a simpler solution is provided. If the angular velocity of the anode varies like for example in the following equation, the likelihood of overheating is reduced significantly. According to this formula the angular velocity ω (t) varies in time according as follows: ω(t)=ω₀+Δω sin Ωt, wherein ω₀ is a mean angular velocity. In particular embodiments Δω fulfils one of the following criteria 1% ω₀≤Δω≤6% ω₀, 2% ω₀, ≤Δω≤5% ω₀, or 3% ω₀≤Δω≤4% ω₀. Further, Ω=2π2Hz may be a preferred value.

Thus in a particular embodiment the time variation of the rotation frequency of the anode is such that the anode rotation frequency and the grid switching frequency, do not coincide. In other words, in this embodiment the frequency of the switched beam and the frequency of the anode plate are not in phase.

In an exemplary embodiment, the proposed solution can be realized by varying the frequency of the electrical current in the stator of the rotation mechanism or by varying the electrical power in the stator of the rotation mechanism or by varying both. However, also other possibilities may be used in order to embody the variation of the angular velocity in time.

According to an exemplary embodiment of the present invention, the rotation mechanism is configured for rotating the anode such that the variation of the angular velocity in time is a continuous oscillation around a mean angular velocity ω₀ in time.

In other words, this embodiment clearly specifies that the continuous rotation of the anode with a changing angular velocity in time is not to be seen as an acceleration or deceleration of the anode from zero speed, i.e. from a “stop or pause period”, with a subsequent acceleration towards working speed. Therefore, the angular velocity of the anode of this embodiment is to be understood as periodically increasing and decreasing around a mean value which is different from zero.

According to an exemplary embodiment of the present invention, the rotation mechanism comprises a stator-rotor combination, which is configured for rotating the anode. Furthermore, the rotation mechanism is configured for varying the frequency of the electrical current in the stator for varying the angular velocity in time, and/or wherein the rotation mechanism is configured for varying the electrical power in the stator for varying the angular velocity in time. 2

As can be gathered for example from FIG. 1 and the corresponding description, an electric motor may be used which comprises a stator and a rotor. The stator is the stationary part of a rotary system found in such an electric motor. Energy flows through a stator to or from the rotating component of the system. In an electric motor, the stator provides a rotating magnetic field that drives the rotating armature, in the present case the rotating armature is the anode. A control unit may be comprised in the rotation mechanism which controls the variation of the frequency of the electrical current in the stator and/or which controls the variation of the electrical power in the stator such that the desired variation of the angular velocity of the anode in time is achieved. In an exemplary embodiment, the formula 1 as described above and hereinafter is stored in a storage unit in combination with such a control device such that the angular velocity of the anode varies as described by this formula 1. In an example, the necessary variation of the frequency of the electrical current in the stator is predefined and stored in said control unit such that the desired angular velocity of the anode is achieved. The same holds true for the variation of electrical power, which is needed to achieve said desired variation of the angular velocity in time of the anode. rotation mechanism is configured for varying the angular velocity in time such

According to another exemplary embodiment of the present invention, thethat the angular velocity of the anode follows a predefined time development and does not require measuring and controlling a rotation frequency of the anode.

In contrast to x-ray tubes, which precisely measure, and control the rotation frequency of the anode with a feedback loop, this embodiment of the present invention provides for a cost-efficient and non-complex solution, which nevertheless provides the advantage of reducing unfortunate heating of the anode plate for a large amount of electron beam switching patterns. In contrast to accurately measuring the speed of the anode and the necessary adjustment of that speed in case of a detected difference between the actual anode speed and the desired anode speed, predefining the time development of the variation of the angular velocity is a less error-prone and less complex solution providing for an improved computer tomography x-ray tube.

According to another exemplary embodiment of the present invention, the computer tomography x-ray tube comprises a grid switch for generating the pulsed electron beam onto the anode.

A grid switch is a device, which allows quickly turning x-ray radiation on and off. In particular, a grid switch consists of a grid aperture, which is mounted in the space between cathode and anode. The electronics of the grid switch allows changing the voltage at this aperture quickly. Typical values of these voltages are +12 kV and −12 kV. Electrical fields arising from the aperture either allow electrons originating from the cathode to pass through to the anode, or these fields prevent the electrons from passing the aperture such that no x-ray radiation is generated.

Thus, using a grid switch in x-ray tubes allows switching the electron beam on and off in very short intervals. However, care must be taken that the electron beam does not hit the same positions of the anode plate after each rotation since this would lead to non-uniform heating. Since heating up identical areas of the anode after each rotation can mean a major drawback, in the presented embodiment the rotation mechanism ensures that the anode rotates with an angular velocity varying in time. Therefore, also in x-ray tubes of computer tomography systems using grid switches, the likelihood of local overheating of the anode is significantly reduced.

According to another exemplary embodiment of the present invention, the x-ray tube is embodied as a stereo tube in which two focal spots of electron beams are generated in an alternating manner.

In a stereo tube, the targeted power for each focal spot can get quite high during periods of illumination. Therefore, heating up identical areas of the anode after each rotation can also mean a major drawback in this setup. The rotation mechanism of the present invention which ensures that the anode rotates with an angular velocity that varies in time, the likelihood of local overheating of the anode is also reduced in such stereo tube embodiments.

According to another exemplary embodiment of the present invention, the angular velocity varies in time according to the following formula,

ω(t)=ω₀+Δω sin Ωt,

wherein ω₀ is a mean angular velocity.

In this embodiment, a particular, predefined time development of the angular velocity of the anode is defined by this formula. Such a formula may be stored in a storage device and/or a control unit of the computer tomography x-ray tube to ensure that the rotation mechanism urges the anode to undergo exactly such a movement described by this formula.

According to another exemplary embodiment of the present invention, Δω fulfils one of the following criteria 1% ω₀≤Δω≤6% ω₀, 2% ω₀≤Δω≤5% ω₀, and 3% ω₀≤Δω≤4% ω₀.

The exemplified values for Δω are chosen such that sufficient variation is realized for obtaining the targeted benefits with respect to heating, while values for Aw are kept as small as possible for staying as close as possible to the target frequency ω₀.

In a further preferred embodiment Ω=2π2 Hz. This preferred value for Ω is chosen such that the targeted variation can be obtained with adequate electrical power. According to another exemplary embodiment of the present invention, the electron emission unit is configured for generating the pulsed electron beam with the pulse duration between 10 microseconds and a few hundred milliseconds.

According to another exemplary embodiment of the present invention, a computer tomography device for generating images of a patient is presented. The computer tomography device comprises an x-ray tube according to any of the embodiments and aspects described herein. Furthermore, the computer tomography device comprises a gantry and the computer tomography device is configured to cause the gantry to undergo a rotational movement during imaging. Furthermore, the angular velocity of the anode and the rotational movement of the gantry during imaging are desynchronized due to the variation in time of the angular velocity of the anode.

A particular embodiment of this aspect of the present invention is described and shown with respect to FIG. 2.

In particular, the variation of the angular velocity in time of the anode ensures that during a rotational movement of a gantry in a CT device during imaging, the angular velocity of the anode and said rotational movement are desynchronized. This cost-efficient solution does not require a complex controlling mechanism of the angular velocity of the anode but at the same time reduces the unfortunate heating of the anode plate significantly. This is true for nearly all electron beam switching patterns and is of particular advantage if grid switches and/or stereo tubes with two focal spots of electron beams are used.

According to another aspect of the present invention, a method of generating pulsed x-ray radiation with a rotating anode and a pulsed electron beam is presented. The method comprises the steps of emitting the pulsed electron beam onto the anode and rotating the anode with an angular velocity, which varies in time.

As has been mentioned hereinbefore in detail, the anode may be rotated such that the variation of the angular velocity in time is a continuous oscillation around the mean angular velocity Wo in time. In a further particular embodiment, the angular velocity is varied in time such that the angular velocity of the anode follows a predefined time development. In other words, this distinguishes from situations where x-ray tubes are operated in an on and off mode thereby accelerating from time to time the anode to a working speed and then switching off again the rotation.

According to another exemplary embodiment of the present invention, the electron beam is pulsed by a grid switch that is part of the x-ray tube.

According to another exemplary embodiment of the present invention, the method comprises the steps of driving the anode rotation by a stator-rotor combination, varying a frequency of electrical current in the stator thereby causing a continuous oscillation in time of the angular velocity of the anode around a mean angular velocity ω₀, and/or varying electrical power in the stator thereby causing a continuous oscillation in time of the angular velocity of the anode around a mean angular velocity ω₀.

These and other features of the invention will become apparent from and elucidated with reference to the embodiments described hereinafter.

### BRIEF DESCRIPTION OF THE DRAWINGS

FIG. 1 schematically shows a computer tomography x-ray tube according to an exemplary embodiment of the present invention.

FIG. 2 schematically shows a computer tomography device for generating images of a patient according to an exemplary embodiment of the present invention.

FIG. 3 schematically shows a flow diagram of a method of generating pulsed x-ray radiation with a rotating anode and a pulsed electron beam according to an exemplary embodiment of the present invention.

Exemplary embodiments of the invention will be described in the following drawings.

### DETAILED DESCRIPTION OF EMBODIMENTS

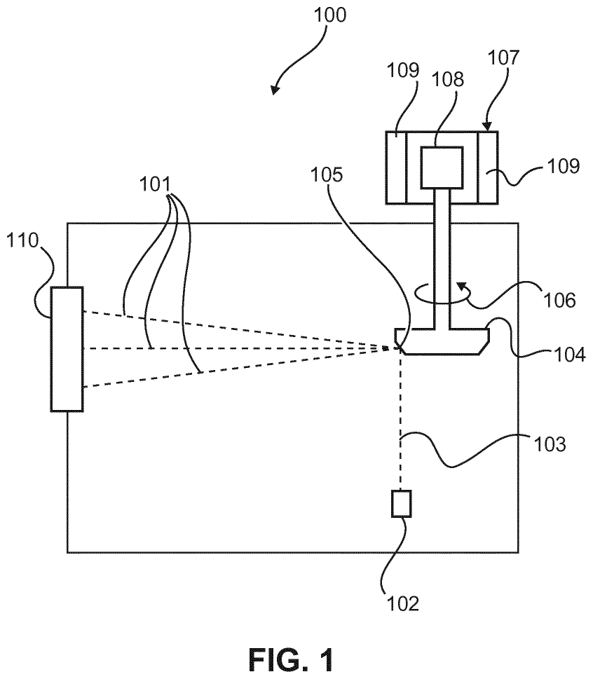

FIG. 1 schematically shows a computer tomography x-ray tube 100 for generating pulsed x-ray radiation. The x-ray tube 100 comprises an anode 104, an electron emission unit 102 for generating a pulsed electron beam 103 onto the anode 104. A rotation mechanism 107 for rotating the anode 104 is comprised as well. The rotation mechanism 107 is configured for rotating the anode 104 with an angular velocity, which varies in time. The rotation of the anode 104 is shown with arrow 106. The pulsed electron beam 103 is focused onto focal spot 105 of the anode 104 where the x-ray radiation 101 is generated. The x-ray radiation may exit the x-ray tube 100 via the radiation window 110. In the embodiment shown in FIG. 1, the rotation mechanism 107 comprises a stator 109 as well as a rotor 108, which is configured for rotating the anode 104. In this embodiment, the stator-rotor combination is configured for varying the frequency of the electrical current running through the stator 109 such that the angular velocity is varying in time as desired. Furthermore, the rotation mechanism is configured for varying the electrical power in the stator 109 such that the angular velocity of the anode is varying in time. The electric motor used in the embodiment of FIG. 1 for creating the rotation of the anode may comprise a controller (not shown), which ensures that the angular velocity in time is a continuous oscillation around a mean angular velocity ω₀ in time.

The electron emission unit 102 may comprise several different components. In particular, the cathode, which emits the electron of the pulsed electron beam is comprised by the electron emission unit 102. Preferably, also a grid switch is comprised by the electron emission unit 102, which allows for a switching of the electron beam in an on and off state in very short time intervals. Care must be taken that the electron beam does not hit the same positions of the anode plate after each rotation since this would lead to non-uniform heating. A special case is given by a stereo tube, in which two focal spots are used in an alternating manner. Here, the targeted power for each focal spot can get quite high during periods of illumination. Therefore, heating up identical areas of the anode after each rotation can mean a major drawback. Therefore, the embodiment of FIG. 1 provides for the rotation mechanism, which is configured for rotating the anode with an angular velocity which varies in time. Thus, the likelihood of an unfortunate heating of the anode will significantly be reduced. This is true for nearly all electron beam switching patterns. The proposed solution of the CT x-ray tube 100 with an anode plate where the angular velocity varies with time is cost-efficient and no complex controlling mechanism is required.

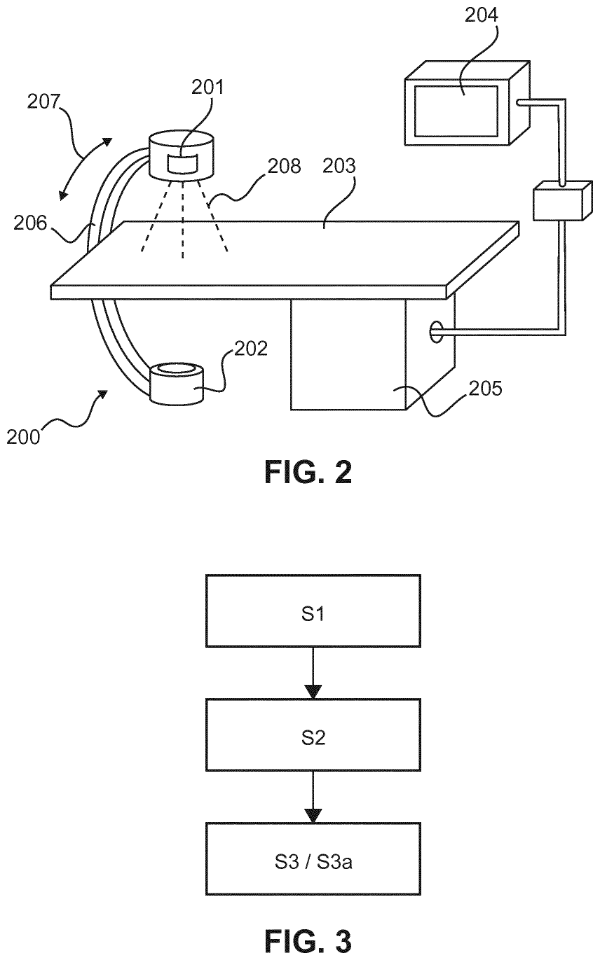

In other words, the embodiment shown in FIG. 1 as an exemplary example can have a grid switch for generating the pulsed electron beam 103. Furthermore, the x-ray tube can be embodied as a stereo tube, in which two focal spots of electron beams are generated in an alternating manner. The computer tomography x-ray tube 100 is particularly used in computer tomography devices for generating images of a patient, as will be described in more detail hereinafter in the context of FIG. 2.

According to an exemplary embodiment of an aspect of the present invention, FIG. 2 shows a computer tomography device 200 for generating images of a patient. The computer tomography device 200 comprises an x-ray tube 201, which is located in an upper part of gantry 206. Gantry 206 is rotatable around an axis, which extends along the patient positioning table 203. The rotational movement of gantry 206 is indicated by arrow 207. The x-ray radiation 208 emitted by the computer tomography x-ray tube 201 can be detected after being transmitted through the patient by x-ray detector 202. A movement mechanism 205, which is capable of positioning the table 203 with respect to x-ray tube 201 allows an accurate positioning of the patient. Furthermore, the created CT images can be shown on display 204 to the medical practitioner after image acquisition. The computer tomography device 200 is configured to cause the gantry 206 to undergo a rotational movement 207 during imaging. Furthermore, the angular velocity of the anode 104 and the rotational movement of the gantry 206 during imaging are desynchronized due to the variation in time of the angular velocity of the anode taking place in the x-ray tube 201.

In particular, the variation of the angular velocity in time of the anode ensures that during a rotational movement of a gantry in a CT device during imaging, the angular velocity of the anode and said rotational movement are desynchronized. This cost-efficient solution does not require a complex controlling mechanism of the angular velocity of the anode but at the same time reduces the unfortunate heating of the anode plate significantly. This is true for nearly all electron beam switching patterns and is of particular advantage if grid switches and/or stereo tubes with two focal spots of electron beams are used.

In an exemplary embodiment, the CT may comprise a grid switch with a rotating anode plate within the tube drivable by a stator-rotor combination with a mechanism for varying the angular velocity of the anode plate. In a particular embodiment, the angular velocity of the anode plate varies like in the following equation

ω(t)=ω₀+Δω sin Ωt,

wherein ω₀ is a mean angular velocity. According to another exemplary embodiment of the present invention, Δω fulfils one of the following criteria 1% ω₀≤Δω≤6% ω₀, 2% ω₀≤Δω≤5% ω₀, and 3% ω₀≤Δω≤4% ω₀. The exemplified values for Δω are chosen such that sufficient variation is realized for obtaining the targeted benefits with respect to heating, while values for Δω are kept as small as possible for staying as close as possible to the target frequency ω₀. In a further preferred embodiment Ω=2π2 Hz. This preferred value for Ω is chosen such that the targeted variation can be obtained with adequate electrical power.

The proposed solution can preferably be realized by varying the frequency of the electrical current in the stator of the rotation mechanism or by varying the electrical power in the stator of the rotation mechanism or by varying both. In any case, the likelihood of local overheating of the anode is reduced significantly by varying the angular velocity in time.

According to another exemplary embodiment of the present invention, FIG. 3 shows a flow diagram of a method of generating pulsed x-ray radiation with a rotating anode and a pulsed electron beam. The method comprises the steps of emitting the pulsed electron beam onto the anode S1 and rotating the anode with an angular velocity which varies in time S3. In the embodiment of FIG. 3, the anode rotation is caused by driving the anode by a stator-rotor combination. Moreover, by varying a frequency of the electrical current and the stator, a continuous oscillation in time of the angular velocity of the anode around a mean angular velocity is caused. Alternatively or in addition, varying the electrical power in the stator is comprised by the method thereby causing a continuously oscillation in time of the angular velocity of the anode around a mean angular velocity ω₀. In step S2 the anode rotation is driven by a stator-rotor combination. The step of varying the frequency of the electrical current in the stator thereby causing a continuous oscillation in time of the angular velocity of the anode around a mean angular velocity ω₀, and/or varying the electrical power in the stator thereby causing a continuous oscillation in time of the angular velocity of the anode around a mean angular velocity ω₀ is shown in FIG. 3 with S3a.

In a particular embodiment of the method of FIG. 3, the electron beam is pulsed by using grid switch. Such grid switch, which allows quickly turning x-ray radiation on and off. In particular, the grid switch consists of a grid aperture, which is mounted in the space between cathode and anode. The electronics of the grid switch allows changing the voltage at this aperture quickly. Typical values of these voltages are +12 kV and −12 kV. Electrical fields arising from the aperture either allow electrons originating from the cathode to pass through to the anode, or these fields prevent the electrons from passing the aperture such that no x-ray radiation is generated.

1. A computed tomography x-ray tube for generating pulsed x-rays, comprising:
an anode;
an electron emission configured to generate a pulsed electron beam onto the anode, wherein the electron emission comprises a grid switch for generating the pulsed electron beam; and
a rotation mechanism for rotating the anode, wherein the rotation mechanism is configured to rotate the anode with an angular velocity which varies in time,
such that the variation of the angular velocity in time is a continuous periodic oscillation around a mean angular velocity in time, and
wherein a rotational frequency of the anode and a switching frequency of the grid switch do not coincide.

2. The computed tomography x-ray tube according to claim 1,
wherein the rotation mechanism comprises a stator-rotor combination configured to rotate the anode, and
wherein the rotation mechanism is configured to vary in the stator at least one of a frequency of an electrical current and an electrical power.

3. The computed tomography x-ray tube according to claim 1, wherein the rotation mechanism is configured to vary the angular velocity in time such that the angular velocity of the anode follows a predefined time development and does not require measuring and controlling a rotation frequency of the anode.

4. The computed tomography x-ray tube according to claim 1, wherein the x-ray tube is a stereo tube having two focal spots of electron beams generated in an alternating manner.

5. The computed tomography x-ray tube according to claim 1, wherein the angular velocity varies in time according to a following formula:
ω(t)=ω₀+Δω sin Ωt,
wherein ω₀ is the mean angular velocity.

6. The computed tomography x-ray tube according to claim 5, wherein Δω fulfils one of 1% ω₀≤Δω≤6% ω₀, 2% w₀≤Δω≤5% w₀, and 3% ω₀≤Δω≤4% ω₀.

7. The computed tomography x-ray tube according to claim 5, wherein Ω is 2π2 Hz.

8. The computed tomography x-ray tube according to claim 1, wherein the electron emission is configured to generate the pulsed electron beam with a pulse duration between 10 microseconds and 500 milliseconds, between 10 microseconds and 250 milliseconds, or between 10 microseconds and 100 milliseconds.

9. The computed tomography device for generating images of a patient, the computer tomography device comprising:
an x-ray tube according to claim 1; and
a gantry,
wherein the computed tomography device is configured to cause the gantry to undergo a rotational movement during imaging, and
wherein the angular velocity of the anode and the rotational movement of the gantry during imaging are de-synchronized due to the variation in time of the angular velocity of the anode.

10. A method of generating pulsed x-ray radiation with a rotating anode and a pulsed electron beam, comprising:
emitting the pulsed electron beam onto the anode; and
rotating the anode with an angular velocity which varies in time,
wherein the anode is rotated such that the variation of the angular velocity in time is a continuous oscillation around a mean angular velocity in time, and
wherein the electron beam is pulsed by a grid switch, wherein a rotational frequency of the anode and a switching frequency of the grid switch do not coincide.

11. The method according to claim 11, further comprising:
driving the anode rotation by a stator-rotor combination, and
varying in the stator at least one of a frequency of an electrical current and an electrical power to cause a continuous oscillation in time of the angular velocity of the anode around the mean angular velocity.
